(19) United States
(12) Patent Application Publication
(10) Pub. No.: US 2014/0297644 A1
(43) Pub. Date: Oct. 2, 2014

(54) Knowledge graph mining method and system

(71) Applicant: TENCENT TECHNOLOGY (SHENZHEN) COMPANY LIMITED, Shenzhen (CN)

(72) Inventor: Gang Cheng, Shenzhen (CN)

(21) Appl. No.: 14/273,733

(22) Filed: May 9, 2014

Related U.S. Application Data
(63) Continuation of application No. PCT/CN2014/073556, filed on Mar. 17, 2014.

(30) Foreign Application Priority Data
Apr. 1, 2013 (CN) 2013101124079

(51) Int. Cl. G06F 17/30

(52) U.S. Cl. CPC G06F 17/30958; G06F 17/30312; G06F 17/30539
USPC 707/737

(57) ABSTRACT

It is described a knowledge graph mining method, including: users in a community are clustered to form a community user circle according to original community data of the users, attributes of the users, a bulletin board system participated by the users, or a chat group of an instant messaging application participated by the users, wherein the original community data of a user comprise information about following-up of the user on another user in the community, and an amount of topics which both the user and the another user take part in; and a knowledge graph corresponding to the community user circle is created according to user behavior data generated by users in the community user circle.

### CROSS-REFERENCE TO RELATED APPLICATIONS

This is a continuation application of International Patent Application No. PCT/CN2014/073556, filed on Mar. 17, 2014, which claims priority to Chinese Patent Application No. 201310112407.9 filed on Apr. 1, 2013, the disclosure of which is hereby incorporated by reference herein in its entirety.

### TECHNICAL FIELD

In various embodiments, the present disclosure relates to the field of computers, and in particular to a computer-implemented knowledge graph mining method, and an associated system.

### BACKGROUND

With the rapid development of the search engine on the Internet, knowledge graphs show up. Based on a keyword input by a user, the search engine searches out from a knowledge graph words related to the keyword, which then are displayed to the user.

### SUMMARY

According to an aspect of the present disclosure, it is provided a method, including:

at a computing device having one or more processors and memory for storing one or more programs to be executed by the one or more processors,

users in a community are clustered to form a community user circle according to original community data of the users, attributes of the users, a bulletin board system participated by the users, or a chat group of an instant messaging application participated by the users, wherein the original community data of a user include information about following-up of the user on another user in the community, and an amount of topics which both the user and the another user take part in; and

a knowledge graph corresponding to the community user circle is created according to user behavior data generated by users in the community user circle.

According to another aspect of the present disclosure, it is provided a system, including: at least a processor operating in conjunction with a memory and a plurality of components, the plurality of components including:

a clustering module, configured to cluster users in a community to form a community user circle according to original community data of the users, attributes of the users, a bulletin board system participated by the users, or a chat group of an instant messaging application participated by the users, wherein the original community data of a user include information about following-up of the user on another user in the community, and an amount of topics which both the user and the another user take part in; and

a creating module, configured to create a knowledge graph corresponding to the community user circle according to user behavior data generated by users in the community user circle.

According to a further aspect of the present disclosure, it is provided a non-transitory computer-readable storage medium storing instructions thereon for execution by at least one processing circuit, the instructions including:

clustering users in a community to form a community user circle according to original community data of the users, attributes of the users, a bulletin board system participated by the users, or a chat group of an instant messaging application participated by the users, wherein the original community data of a user include information about following-up of the user on another user in the community, and an amount of topics which both the user and the another user take part in; and

creating a knowledge graph corresponding to the community user circle according to user behavior data generated by users in the community user circle.

This section provides a general summary of the disclosure, and is not a comprehensive disclosure of its full scope or all of its features. Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

In the following, embodiments of the present disclosure will be discussed with reference to drawings. It should be understood that the drawings illustrate generally, by way of example, but not by way of limitation, various embodiments discussed in the present disclosure.

FIG. 1 is a flowchart of a knowledge graph mining method according to some embodiments.

FIG. 2 is a flowchart of a knowledge graph mining method according to some embodiments.

FIG. 3 is a flowchart of a knowledge graph mining method according to some embodiments.

FIG. 4 is a block diagram illustrating a knowledge graph mining system according to some embodiments.

FIG. 5 is a structure schematic view illustrating a knowledge graph mining device according to some embodiments.

### DETAILED DESCRIPTION

The embodiments of the present disclosure are elaborated in combination with the figures below in detail, so as for better understanding of the present disclosure.

In order for its utilization in the search engine, a knowledge graph should be mined out beforehand. In a knowledge graph mining method, analysis is performed on each literature in a literature library to get relevancies between words contained in literatures, then based on which the knowledge graph is constructed. When receiving a keyword input by a user, the search engine searches out words related to the keyword from the knowledge graph.

A word may have different meanings in different scenarios. A user in a scenario may prefer words corresponding to the scenario could be searched out based on a keyword. However, such desired words are flooded by numerous words related to the keyword but not associated with the scenario, causing poor accuracy in searching for desired related words.

Embodiments disclosed herein further take into account this situation and make an attempt to improve search accuracy.

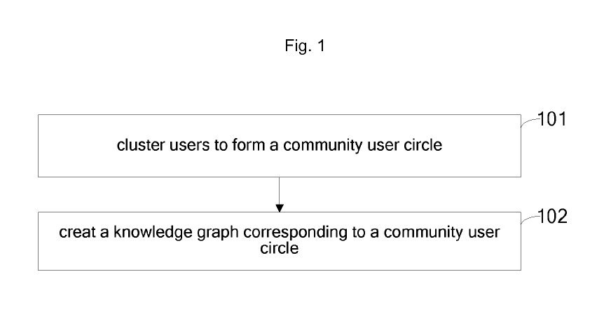

Referring to FIG. 1, which is a flowchart of a knowledge graph mining method according to some embodiments.

In step 101, according to original community data of users in a community, attributes, participated Bulletin Board Systems (BBS), or participated chat groups (for example, of an instant messaging application) of users in a community, users may be clustered to form a community user circle.

In some examples, the original community data of a user may include information about following-up of a user on another user in the same community, and the amount of topics which both the user and the another user take part in.

In some examples, the attribute of a user may include at least one of age, location, educational background, salary, and so on.

In step 102, a knowledge graph corresponding to the community user circle may be created according to user behavior data generated by users in the community user circle.

In this way, when a user belonging to a community user circle wants to search for words associated with the community user circle based on a keyword, he/she may search out desired words from the knowledge graph corresponding to the community user circle, thus improving accuracy in searching for such desired words.

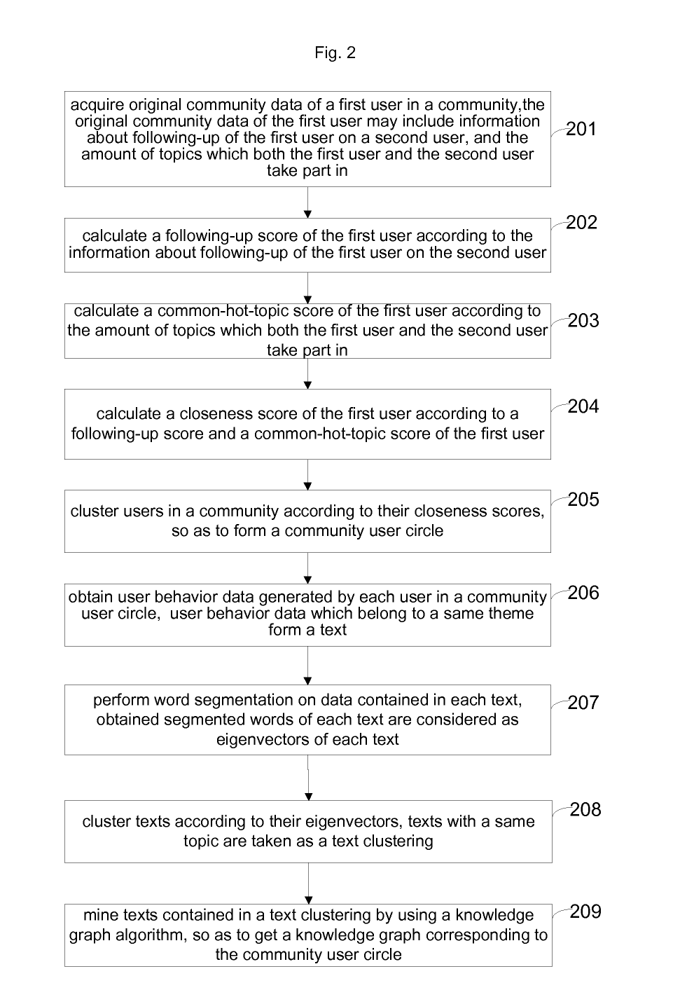

Referring to FIG. 2, which is a flowchart of a knowledge graph mining method according to some embodiments.

In step 201, it may be acquired original community data of a first user in a community. The original community data of the first user may include information about following-up of the first user on each of other users in the community (for example, referred to as a second user), and the amount of topics which both the first user and the second user in the community take part in.

The information about following-up of the first user on the second user in the community may include at least one of the following: information indicating whether the first user listens to (or tunes in to) the second user in the community, the number of times the first user reposts content which have been posted by the second user, the number of times the first user comments on content which have been posted by the second user, the number of times the first user sends public messages (for example, by using the mention function of a microblog, “@name”) to the second user, and the number of times the first user sends private messages (for example, by using the chat function of a microblog) to the second user.

In some examples, the information indicating whether the first user listens to the second user in the community may include an identity of the second user listened to by the first user.

In some examples, it may be stored in a server of a community, listen-to information of each user, the number of times each user reposts content which have been posted by other users, the number of times each user comments on content which have been posted by other users, the number of times each user sends public messages to other users, the number of times each user sends private messages to other users, and community topics which each user takes part in.

As such, for a user in a community, it may be obtained from a server of the community at least one of the following: the listen-to information of the user indicating whether the user listens to other users in the community, the number of times the user reposts content which have been posted by other users, the number of times the user comments on content which have been posted by other users, the number of times the user sends public messages to other users, the number of times the user sends private messages to other users, and community topics which the user takes part in.

In some examples, it may be determined community topics which both a first user and a second user take part in according to community topics which the first user takes part in and community topics which the second user take part in.

In step 202, it may be calculated a following-up score of the first user on the second user according to the information about following-up of the first user on the second user.

In some examples, the following-up score of the first user may include at least one of: a listen-to score, a repost-and-comment score, a public-message sending score, a private-message sending score.

In some examples, a listen-to score of the first user may be calculated according information indicating whether the first user listens to the second user in the community.

In some examples, a listen-to score of the first user may be calculated through the formula (1).

z(i,j)={₀¹ formula (1),

where z(i, j) is a listen-to score of the user i with respect to the user j. i may be a first user in a community, and j may be any one of other users in the community (referred to as the second user).

z(i, j) may indicate whether the user i listens to the user j. If the user i listens to the user j, then the listen-to score of the user i is z(i, j)=1. If the user i does not listen to the user j, then the listen-to score of the user i is z(i, j)=0.

In some examples, a repost-and-comment score of the first user may be calculated according to the number of times the first user reposts content which have been posted by the second user and the number of times the first user comments on content which have been posted by the second user.

In some examples, a repost-and-comment score of the first user may be calculated through the formula (2).

f(i,j)=x+y formula (2),

where f(i, j) is a repost-and-comment score of the user i with respect to the user j, i may be the first user in a community, j may be the second user in the community, x is the number of times the user i reposts content which have been posted by the user j, and y is the number of times the user i comments on content which have been posted by the user j.

In some examples, a public-message sending score of the first user may be calculated according to the number of times the first user sends public messages to the second user.

In some examples, a public-message sending score of the first user may be calculated through the formula (3).

g(i,j)=x formula (3),

where g(i, j) is a public-message sending score of the user i with respect to the user j, i may be the first user in a community, j may be the second user in the community, and x is the number of times the user i sends public messages to the user j.

In some examples, a private-message sending score of the first user may be calculated according to the number of times the first user sends private messages to the second user.

In some examples, a private-message sending score of the first user may be calculated through the formula (4).

h(i,j)=x formula (4),

where h(i, j) is a private-message sending score, i may be the first user in a community, j may be the second user in the community, and x is the number of times the user i sends private messages to the user j.

In step 203, it may be calculated a common-hot-topic score of the first user with respect to the second user according to the amount of topics which both the first user and the second user take part in.

In some examples, a common-hot-topic score of the first user may be calculated through the formula (5).

l(i,j,x)=x formula (5),

where l(i, j, x) is a common-hot-topic score of the user i with respect to the user j, i may be the first user in a community, j may be the second user in the community, and x is the amount of topics which both the user i and the user j take part in.

In step 204, it may be calculated a closeness score of the first user with respect to the second user according to a following-up score and a common-hot-topic score of the first user with respect to the second user.

In some examples, a closeness score of the first user may be used for indicating how close the first user is to the second user who is located in a same community as the first user.

In some examples, a closeness score of the first user may be calculated through the formula (6).

$$dis\_score ( i , j ) = \frac{1}{\begin{matrix}α * z ( i , j ) + β * f ( i , j ) + \\ γ * g ( i , j ) + δ * h ( i , j ) + ɛ * I ( i , j , x )\end{matrix}} , \qquad formula ( 6 )$$

where dis_score (i, j) is a closeness score indicative of the degree of the closeness of the user i to the user j, i may be the first user in a community, j may be the second user in the community, z(i, j), f(i, j), g(i, j), h(i, j) and I(i, j, x) are as described in formulae (1)-(5) respectively, α, β, γ, δ and ε are preset and α+β+γ+δ+ε=1. One or more of α, β, γ, δ and ε may be zero. When for example α=0, there is no need to calculate z(i, j).

In some examples, the lower the dis_score (i, j) is, the closer is the user i to the user j. The higher the dis_score (i, j) is, the further the user i is distant from the user j.

For example, the original community data of the user i with respect to the user j, the original community data of the user j with respect to the user i, and respective scores of the users i and j are shown in Table 1. And in the example, each of α, β, γ, δ and ε is preset as 0.2.

TABLE 1

| | | number of | number of | number of | number of | |
|---|---|---|---|---|---|---|
| | information | times one | times one | times one | times one | |
| | indicating | party | party | party | party | |
| | whether | comments | reposts | sends | sends | |
| | one party | on content | content | public | private | amount |
| | listens to | posted by | posted by | messages | messages | of |
| community | the other | the other | the other | to the other | to the other | common |
| user | party | party | party | party | party | topics |
| user i | yes | 10 | 5 | 7 | 3 | 5 |
| user j | yes | 5 | 6 | 3 | 1 | 5 |

| | | | | | |
|---|---|---|---|---|---|
| (i, j) | 1 | 15 | 7 | 3 | 5 |
| (j, i) | 1 | 11 | 3 | 1 | 5 |

The closeness score of the user i with respect to the user j is

$$\begin{matrix}dis\_score ( i , j ) = \frac{1}{\begin{matrix}0.2 * 1 + 0.2 * ( 10 + 5 ) + \\ 0.2 * 7 + 0.2 * 3 + 0.2 * 5\end{matrix}} \\ = 0.1612 .\end{matrix}$$

The closeness score of the user j with respect to the user i is

$$\begin{matrix}dis\_score ( j , i ) = \frac{1}{\begin{matrix}0.2 * 1 + 0.2 * ( 5 + 6 ) + \\ 0.2 * 3 + 0.2 * 1 + 0.2 * 5\end{matrix}} \\ = 0.2381 .\end{matrix}$$

The closeness score of the user i is less than the closeness score of the user j, which indicates the degree of the closeness of the user i to the user j is greater than the degree of the closeness of the user j to the user i.

In step 205, users in a community may be clustered according to their closeness scores, so as to form a community user circle.

In some examples, step 205 may include steps 205-1 to 205-4.

In step 205-1, a user (referred to as a first user) in a community is selected.

In step 205-2, a distance of the first user with respect to another user (referred as the second user) in the community is calculated according to the closeness score of the first user with respect to the second user and the closeness score of the second user with respect to the first user.

In some examples, a distance of the first user with respect to the second user may be calculated through the formula (7).

dis(i,j)=dis_score(i,j)*dis_score(j,i) formula (7),

where dis(i, j) is a distance between the user i (the first user) and the user j (the second user), dis_score (i, j) is the closeness score of the user i with respect to the user j, and dis_score (j, i) is the closeness score of the user j with respect to the user i.

In step 205-3, it is selected users whose distances from the first user are less than a preset user-distance threshold, and the selected users and the first user form a community user circle.

In some examples, the preset user-distance threshold may be less than 1, for example 0.01 or 0.05. The lower the user-distance threshold is, the smaller the circle is.

In step 205-4, for other users in the community, steps 205-1 to 205-3 are also applied.

In some examples, after community user circles are formed, they may be combined, see for example steps 205-11 to 205-17.

In step 205-11, all community user circles form a circle set, and a pointer is directed to a first circle in the circle set.

In step 205-12, it is selected a circle other than the first circle (referred to as a second circle) in the circle set, and it is calculated a distance between the second circle and the first circle according to a closeness score of a user in the first circle with respect to a user in the second circle and a closeness score of a user in the second circle with respect to a user in the first circle.

In some examples, a distance between the second circle and the first circle may be calculated through the formula (8).

C_dis(I,J)=Σⁿ₀dis_score(i,j)*dis_Score(j,i) formula (8),

where C_dis(I, J) is a distance between two different circles I and J (the first circle I and the second circle J), the user i is located in the circle I, the user j is located in the circle J, and n is a selected amount of users in the circle I or J.

In step 205-13, it is determined whether the distance between the first circle and the second circle is less than a preset circle-distant threshold. If yes, proceed to step 205-16 to combine the first circle and the second circle; otherwise, the first circle and the second circle are not combined, and proceed to step 205-14.

In step 205-14, it is determined whether the second circle is the last circle of the circle set. If yes, proceed to step 205-17; otherwise, proceed to step 205-15.

In step 205-15, it is selected a third circle in the circle set, it is calculated a distance between the third circle and the first circle, and back to step 205-13.

In step 205-16, the first circle and the second circle are combined.

In step 205-17, it is determined whether the first circle is the last circle of the circle set. If yes, the process ends; otherwise, the pointer is directed to the second circle of the circle set, back to step 205-12.

It is assumed that there are five community user circles, A, B, C, D and E. The five circles A, B, C, D and E form a circle set {A, B, C, D, E}. A pointer is directed to the circle A. It is calculated a distance between the circle A and the circle B. If the distance between the circle A and the circle B is less than a preset circle-distance threshold, then the circle A and the circle B are combined. Thereafter, the pointer is directed to the circle C, and it is calculated a distance between the circle C and the circle D.

If the distance between the circle A and the circle B is equal to or greater than the preset circle-distance threshold, then the circle A and the circle B are not combined, and it is calculated in turn a distance between the circle C and the circle A. a distance between the circle D and the circle A, a distance between the circle E and the circle A, if these distances are all equal to or greater than the preset circle-distance threshold. Then, the pointer is directed to the circle B, and it is calculated a distance between the circle B and the circle C. The rest may be done in a similar manner.

In some embodiments, users in a community may be clustered to form community user circles according to their eigenvectors. In some examples, the eigenvector of a user may be formed by attributes of the user. The attribute of a user may include at least one of age, location, educational background, salary, and so on.

In some embodiments, users in a community may be clustered to form community user circles according to chat groups or BBSs which they participate in.

In some embodiments, users included in a chat group of an instant messaging application may form a community user circle. Users included in a BBS may form a community user circle.

In step 206, it may be obtained user behavior data generated by each user in a community user circle. User behavior data which belong to a same theme may be formed into a text.

In some examples, after each user in a community generates user behavior data by means of the community, the user behavior data are stored in a server of the community. In this way, user behavior data of a user in a community may be obtained from a server of the community. And the obtained user behavior data which belong to a same theme may be formed into a text.

In case a community is a microblog, a BBS, a post bar, or a blog (e.g. QQzone from Tencent Technology Company Limited), the user behavior data may include a piece of particular content posted in the community and comments on the particular content.

Accordingly, the particular content and the comments thereon, considered as behavior data which belong to a same theme, may be formed into a text.

In case a community is an instant messaging application (e.g. Wechat from Tencent Technology Company Limited), the user behavior data may include a chat message sent by a user to his friend and a reply to the chat message from his friend. The chat message and the reply thereto, considered as behavior data which belong to a same theme, may be formed into a text.

In case a community is a chat group in an instant messaging application, chat history of the chat group within an active period may be formed into a text. The active period may refer to a period during which members of the chat group is more active, compared with other periods. For example, a chat group lasts four hours, there are 100 chat records during a first hour, 50 chat records during a second hour, 10 chat records during a third hour and 5 chat records during a fourth hour. The average activity=(100+50+10+5)/4=41.25 chat records/hour. The first hour, during which the activity is more than two time the average activity, may be selected as the active period.

In step 207, word segmentation may be performed on data contained in each text, so as to get segmented words of each text. The segmented words of each text may be considered as eigenvectors of each text.

In some examples, word segmentation is performed on a text by using a segmented word stock to get one or more segmented words of the text, then from which adverbs and commonly-used words are excluded. The remaining segmented words form eigenvectors of the text.

In some examples, it is determined the frequency that each segmented word of a text appears in all texts. A preset number of segmented words with top frequencies are determined as commonly-used words, and thus they are cleared from the text.

In step 208, texts may be clustered according to their eigenvectors. Texts with a same topic may be taken as a text clustering.

In some examples, a clustering operation may be performed on texts according to their eigenvectors, so that texts with a same topic form a text clustering.

In some examples, we can get, according to eigenvectors of an arbitrary text, a cluster degree between the arbitrary text and another text by using a clustering algorithm. As such, we can get a cluster degree between two random texts. In some examples, two texts with a cluster degree therebetween exceeding a preset threshold may be determined as texts with a same topic, thus forming a text clustering.

In some examples, the clustering algorithm may be a Support Vector Machine (SVM) algorithm, or a k-mediods algorithm.

In step 209, mining may be performed on texts contained in a text clustering by using a knowledge graph algorithm, so as to get a knowledge graph corresponding to the community user circle.

In some examples, it is calculated a relevancy between a first word and any one of other words contained in a text clustering by using a high frequency of co-occurrence method. A preset number (for example 20) of words with top relevancies are taken as words related to the first word. These words together with the first word form a knowledge graph according to their relationships. In some examples, it is preset the amount of words which should be considered as those related to the first word.

With the embodiment, when a user contained in a community user circle wants to search for words related to a specific word, the user may input the name of the community user circle and the specific word into a search engine. The search engine may search out words related to the specific word from a knowledge graph corresponding to the community user circle, and thus accuracy in searching for such desired words are improved.

In the embodiments of the present disclosure, it may be first acquired original community data of users in a community, according to which users of the community may be clustered to form community user circles. Then, it may be acquired user behavior data of users contained in a community user circle, and it may be created a knowledge graph of the community user circle according to these user behavior data. In this way, when a user wants to search in his/her community user circle for words related to a keyword, he/she may search out desired words from a knowledge graph corresponding to the community user circle, thus improving accuracy in searching for such desired words.

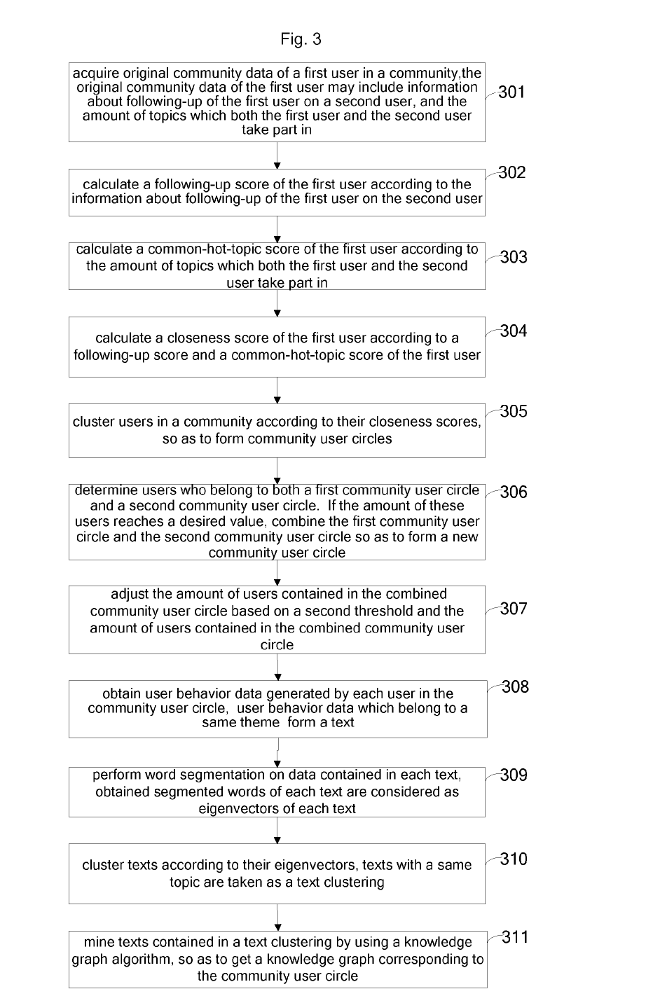

Referring to FIG. 3, which is a flowchart of a knowledge graph mining method according to some embodiments.

Steps 301-304 are same as steps 201-204 in FIG. 2.

In step 305, users in a community may be clustered according to their closeness scores, so as to form community user circles.

In some examples, step 305 may include steps 305-1 to 305-4.

In step 305-1, it is selected a first user in a community, and other users in the community form a first user set. It is calculated a distance of the first user from each user of the first user set through the formula (9).

dis(i,j)=dis_{—score(}i,j)*dis_{—score(}j,i) formula (9),

where dis(i, j) is a distance between the user i (i.e. the first user) and the user j which is a user contained in the first user set, dis_score (i, j) is the closeness score of the user i with respect to the user j, and dis_score (j, i) is the closeness score of the user j with respect to the user i.

In step 305-2, the first user and a user contained in the first user set which has a minimum distance with the first user forms a second user set. Users contained in the first user set but not contained in the second user set are considered as a third user set. It is calculated the amount of effective parties of a user contained in the third user set with respect to the second user set. It is selected a user in the third user set who has the greatest number of effective parties with respect to the second user set. It is determined the amount of a user in the third user set who has the greatest number of effective parties with respect to the second user set.

When the distance between a user i and a user j is less than a user-distance threshold, it means the user i is an effective party of the user j, and the user j is an effective party of the user i. The user-distance threshold may be preset according to actual requirements. The lower the user-distance threshold is, the less the amount of effective parties of a user is.

For example, when the user A and the user B is less than the user-distance threshold, it means the users A and B are effective parties for each other. If the second user set consists of two users and if the distance between a user in the third user set and each of users in the second user set is less than the user-distance threshold, then the user in the third user set has two effective parties.

In step 305-3, if the determined amount of a user in the third user who has the greatest number of effective parties is greater than 0, then it is added the user who has the greatest number of effective parties into the second user set. It is then calculated the amount of the effective party of a user contained in the second user set with respect to each of other users contained in the second user set, and it is determined a user who has the least amount of effective parties. If the number of a user who has the least amount of effective parties is for example, equal to less than one half of the amount of a user who has been just added in the second user set, then it is deleted from the second user set the user who has the least amount of effective parties.

In some examples, if the determined amount of a user in the third user who has the greatest number of effective parties is 0, it is indicated that two users in the second user set who have the smallest distance between each other do not belong to any circles.

In step 305-4, if the amount of users in the second user set is equal to or great than a first threshold and less than or equal to a second threshold, proceed to step 305-8; if the amount of users in the second user set is less than the first threshold, proceed to step 305-5; if the amount of users in the second user set is great than the second threshold, proceed to step 305-6.

In some examples, the first and the second thresholds may be preset according actual requirements. The amount of users contained in the second user set depends on the magnitudes of the first and the second thresholds.

In step 305-5, It is calculated the amount of effective parties of a user contained in the third user set with respect to the second user set. It is selected a user in the third user who has the greatest number of effective parties with respect to the second user set. It is determined the amount of a user in the third user who has the greatest number of effective parties with respect to the second user set. If the determined amount of a user in the third user who has the greatest number of effective parties is 0, proceed to step 305-8; otherwise, return to step 305-3.

If the determined amount of a user in the third user who has the greatest number of effective parties is 0, it is indicated that the second user set is expended as far as to its border.

In step 305-6, it is calculated the amount of the effective party of a user contained in the second user set with respect to each of other users remaining in the second user set, and it is deleted from the second user set the user who has the least amount of effective parties, and then proceed to step 305-7.

In step 305-7, if the amount of users in the second user set is greater than the second threshold, proceed to step 305-6; if the amount of users in the second user set is equal to or less than the second threshold, proceed to step 305-8.

In step 305-8, all users contained in the second user set form a community user circle.

In step 306, it may be determined users who belong to both a first community user circle and a second community user circle. If the amount of users who belong to both the first community user circle and the second community user circle reaches a desired value, the first community user circle and the second community user circle may be combined to form a new community user circle.

In some examples, it is determined users who belong to both a first community user circle and a second community user circle, wherein the first community user circle and the second community user circle are any two of community user circles formed in step 305. It may be determined the first percentage of these users in the first community user circle and the second percentage of these users in the second community user circle. If the first percentage and/or the second percentage are/is greater than a preset percentage, the first community user circle and the second community user circle may be combined.

In step 307, it may be adjusted the amount of users contained in the combined community user circle based on the second threshold and the amount of users contained in the combined community user circle.

In some examples, if the amount of users contained in the combined community user circle is greater than the second threshold, it may be calculated the amount of effective parties of a user contained in the combined community user circle with respect to each of other users contained in the combined community user circle. And it may be deleted from the combined community user circle the user who has the least amount of effective parties. These procedures may be repeated until the amount of users contained in the combined community user circle is equal to or less than the second threshold.

In some examples, the amount of users contained in the community user circle may be adjusted based on the adjusting of the second threshold.

In some embodiments, users in a community may be clustered to form community user circles according to their eigenvectors. In some examples, the eigenvector of a user may be formed by attributes of the user. The attribute of a user may include at least one of age, location, educational background, salary, and so on.

In some embodiments, users in a community may be clustered to form community user circles according to chat groups or BBSs which they participate in.

In some embodiments, users included in a chat group of an instant messaging application may form a community user circle. Users included in a BBS may form a community user circle.

In step 308, it may be obtained user behavior data generated by each user in the community user circle. User behavior data which belong to a same theme may be formed into a text.

In some examples, after each user in a community generates user behavior data by means of the community, the user behavior data are stored in a server of the community. In this way, user behavior data of a user in a community may be obtained from a server of the community. And the obtained user behavior data which belong to a same theme may be formed into a text.

In case a community is a microblog, a BBS, a post bar, or a blog (e.g. QQzone from Tencent Technology Company Limited), the user behavior data may include a piece of particular content posted in the community and comments on the particular content. Accordingly, the particular content and the comments thereon, considered as behavior data which belong to a same theme, may be formed into a text.

In case a community is an instant messaging application (e.g. Wechat from Tencent Technology Company Limited), the user behavior data may include a chat message sent by a user to his friend and a reply to the chat message from his friend. The chat message and the reply thereto, considered as behavior data which belong to a same theme, may be formed into a text.

In case a community is a chat group in an instant messaging application, chat history of the chat group within an active period may be formed into a text. The active period may refer to a period during which members of the chat group is more active, compared with other periods. For example, a chat group lasts four hours, there are 100 chat records during a first hour, 50 chat records during a second hour, 10 chat records during a third hour and 5 chat records during a fourth hour. The average activity=(100+50+10+5)/4=41.25 chat records/hour. The first and the second hours, during which the activity is more than the average activity, may be selected as the active periods.

In step 309, word segmentation may be performed on data contained in each text, so as to get segmented words of each text. The segmented words of each text may be considered as eigenvectors of each text.

In some examples, word segmentation is performed on a text by using a segmented word stock to get one or more segmented words of the text, then from which adverbs and commonly-used words are excluded. The remaining segmented words form eigenvectors of the text.

In some examples, it is determined the frequency that each segmented word of a text appears in all texts. A preset number of segmented words with top frequencies are determined as commonly-used words, and thus they are cleared from the text.

In step 310, texts may be clustered according to their eigenvectors. Texts with a same topic may be taken as a text clustering.

In some examples, a clustering operation may be performed on texts according to their eigenvectors, so that texts with a same topic form a text clustering.

In some examples, we can get, according to eigenvectors of an arbitrary text, a cluster degree between the arbitrary text and another text by using a clustering algorithm. As such, we can get a cluster degree between two random texts. In some examples, two texts with a cluster degree therebetween exceeding a preset threshold may be determined as texts with a same topic, thus forming a text clustering.

In some examples, the clustering algorithm may be a Support Vector Machine (SVM) algorithm, or a k-mediods algorithm.

In step 311, mining may be performed on texts contained in a text clustering by using a knowledge graph algorithm, so as to get a knowledge graph corresponding to a community user circle.

With the embodiment, when a user contained in a community user circle wants to search for words related to a specific word, the user may input the name of the community user circle and the specific word into a search engine. The search engine may search out words related to the specific word from a knowledge graph corresponding to the community user circle, and thus accuracy in searching for such desired words are improved.

In the embodiments of the present disclosure, it may be first acquired original community data of users in a community, according to which users of the community may be clustered to form community user circles. Then, it may be acquired user behavior data generated by users contained in a community user circle, and it may be created a knowledge graph of the community user circle according to these user behavior data. In this way, when a user wants to search in his/her community user circle for words related to a keyword, he/she may search out desired words from a knowledge graph corresponding to the community user circle, thus improving accuracy in searching for such desired words.

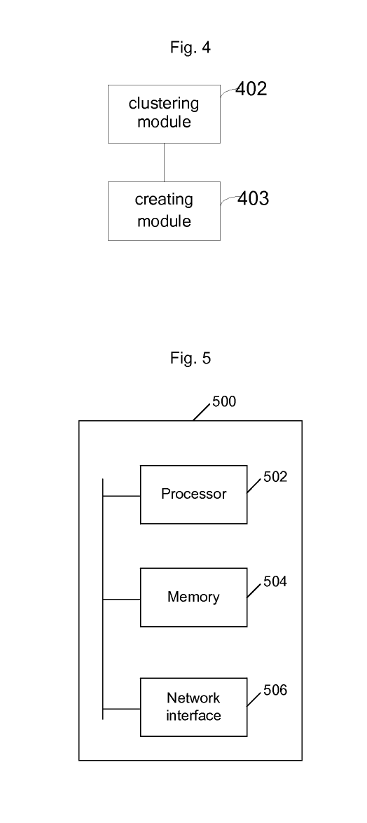

Referring to FIG. 4, which is a block diagram illustrating a knowledge graph mining system according to some embodiments, the knowledge graph mining system may include a clustering module 401 and a creating module 402.

The clustering module 401 is configured to cluster users in a community to form a community user circle according to original community data of the users, attributes of the users, bulletin board systems participated by the users, or chat groups of an instant messaging application participated by the users, wherein the original community data of a user comprise information about following-up of the user on another user in the same community, and an amount of topics which both the user and the another user take part in.

The creating module 402 is configured to create a knowledge graph corresponding to the community user circle according to user behavior data generated by users in the community user circle.

In some examples, the clustering module 401 may include:

a first calculating unit, configured to calculate a closeness score of a user in the community with respect to another user in the community according to original community data of the user, wherein the closeness score of the user is used for indicating a closeness degree of the user with respect to the another user; and

a clustering unit, configured to cluster users according to respective closeness scores of each user with respect to other users, so as to form the community user circle.

In some examples, the first calculating unit may include:

a first calculating sub-unit, configured to calculate a following-up score of a user with respect to another user according to the information about following-up of the user on another user in the community;

a second calculating sub-unit, configured to calculate a common-hot-topic score of the user according to the amount of topics which both the user and the another user take part in; and

a third calculating sub-unit, configured to calculate the closeness score of the user with respect to the another user according to the following-up score and common-hot-topic score of the user with respect to the another user.

In some examples, the clustering unit may include:

a fourth calculating sub-unit, configured to select a user from the community, and to calculate a distance of the user from each of remaining users in the community according to the closeness score of the user with respect to the each of remaining users in the community and the closeness score of the each of remaining users in the community with respect to the user; and

a clustering sub-unit, configured to determine a user whose distance from the user is less than a preset user-distance threshold, the determined user and the user forming the community user circle.

In some examples, the clustering unit may include:

a selecting sub-unit, configured to:
select a user in the community, wherein other users in the community form a first user set; and
calculate respective distances of the selected user with each user of the first user set according to respective closeness scores of the selected user with respect to the each user of the first user set and respective closeness scores of the each user of the first user set with respect to the selected user;

a determining sub-unit, configured to:
form the selected user and a user contained in the first user set which has a minimum distance with the selected user into a second user set, wherein users contained in the first user set but not contained in the second user set are considered as a third user set;
calculate an amount of an effective party of a user contained in the third user set with respect to the second user set; and
determine an amount of a user in the third user who has a greatest amount of effective parties with respect to the second user set;

a deleting sub-unit, configured to:
in the case that the determined amount of the user in the third user who has the greatest amount of effective parties is greater than 0, add the user who has the greatest number of effective parties into the second user set;
calculate an amount of an effective party of a user contained in the second user set with respect to each of other users contained in the second user set;
determine a user who has a least amount of the effective party; and
in the case that an amount of the user who has the least amount of the effective party is less than one half of the amount of the user who has been added in the second user set, delete from the second user set the user who has the least amount of the effective party; and

a clustering sub-unit, configured to in the case that the amount of users in the second user set is equal to or great than a first threshold and less than or equal to a second threshold, form all users contained in the second user set into the community user circle.

a selecting sub-unit, configured to select a

In some examples, the creating module 402 may include:

a forming unit, configured to obtain user behavior data generated by each user of the community user circle, and to form user behavior data which belong to a same theme into a text; and

a mining unit, configured to mine the text to obtain a knowledge graph corresponding to the community user circle.

In some examples, the mining unit may include:

a word-segmentation sub-unit, configured to perform word segmentation on data contained in a text, so as to get segmented words of the text, the segmented words of the text forming eigenvectors of the text;

a second clustering sub-unit, configured to cluster texts according to eigenvectors of each text, texts with a same topic forming a text clustering; and

a mining sub-unit, configured to mine texts contained in a text clustering to obtain the knowledge graph corresponding to the community user circle.

With these embodiments, when a user belonging to a community user circle wants to search for words associated with the community user circle based on a keyword, he/she may search out desired words from a knowledge graph corresponding to the community user circle, thus improving accuracy in searching for such desired words.

It should be understood that a knowledge graph mining system in embodiments of the present application may be a distributed system. For example, some modules, units, or sub-units of a system may be located in a computing device (e.g. a server), while other modules, units or sub-units of the system may be located in another computing device. Alternatively, a knowledge graph mining systems in embodiments of the present application may be located in a single computing device, for example located in a single server.

Referring to FIG. 5, which is a structure schematic view illustrating a knowledge graph mining device according to some embodiments. Herein, the knowledge graph mining device may be implemented as a computer equipment 500. This disclosure contemplates any suitable types of computer equipments 400 for implementing the knowledge graph mining device. As an example and not by way of limitation, the computer equipment 500 may include one or more servers. In an example, software running on the one or more servers performs one or more steps of the method as described referring to FIG. 1, FIG. 2 or FIG. 3, or implements functions of the various modules or units as described referring to FIG. 4.

In an example, the computer equipment 500 includes a processor 502, a memory 504 and a network interface 506. Although this disclosure describes and illustrates a particular computer equipment having a particular number of particular components in a particular arrangement, any suitable computer equipment having any suitable number of any suitable components can be contemplated.

In an embodiment, the processor 502 includes hardware for executing instructions, for example, one or more computer programs. The processor 502 may retrieve instructions from the memory 504 and execute them. The processor 502 may be implemented as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform one or more of the method steps as described referring to FIG. 1, FIG. 2 or FIG. 3, or to implement the various modules or units as described referring to FIG. 4.

In an example, the memory 504 may store instructions for the processor 502 to execute or data for the processor 502 to operate on. In an example, the memory 504 may include random access memory (RAM), which may be dynamic RAM (DRAM) or static RAM (SRAM) as desired. Additionally, the memory 504 may include storage for storing data and instructions, such as read-only memory (ROM), such as mask-programmed ROM, programmable ROM (PROM), erasable PROM (EPROM), electrically erasable PROM (EEPROM), electrically alterable ROM (EAROM), or flash memory. In an example, the storage may be internal or external to computer equipment 500. In an embodiment, the storage stores instructions for performing one or more of the method steps as described referring to FIG. 1, FIG. 2 or FIG. 3, or for implementing the various modules or units as described referring to FIG. 4. The data being downloaded by the wireless terminal may also be located in this storage, or may be located in a storage locally connected to this storage, or may be located in a storage remote to this storage. As an example and not by way limitation, the computer equipment 500 may load instructions from the storage or other sources (for example, remote sources) to the RAM, and then the processor 502 may retrieve the instructions from the RAM to execute them. In an embodiment, the memory 504 may include one or more memories.

In an embodiment, the network interface 506 enables the computer equipment 500 to access a network (for example, a personal area network (PAN), a local area network

(LAN), a wide area network (WAN), a WIFI network, a mobile communication network, etc.) for communication with one or more other devices, for example, the data provider and the wireless terminal.

Herein, one or more computer readable storage media may be contemplated for implementing any suitable storage. In an embodiment, a computer readable storage medium may implement at least some portions of the memory 504. For example, the computer readable storage medium may include both ROM and RAM. The computer readable storage medium may be implemented as a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or any other suitable computer-readable storage medium.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

The terminology used in the description of the invention herein is for the purpose of describing particular examples only and is not intended to be limiting of the invention.

As used in the description of the invention and the appended claims, the singular forms “a,” “an,” and “the” are intended to include the plural forms as well, unless the context clearly indicates otherwise. Also, as used in the description herein and throughout the claims that follow, the meaning of “in” includes “in” and “on” unless the context clearly dictates otherwise. It will also be understood that the term “and/or” as used herein refers to and encompasses any and all possible combinations of one or more of the associated listed items. It will be further understood that the terms “may include,” “including,” “comprises,” and/or “comprising,” when used in this specification, specify the presence of stated features, operations, elements, and/or components, but do not preclude the presence or addition of one or more other features, operations, elements, components, and/or groups thereof.

Although the terms first, second, etc. may be used herein to describe various elements, these elements should not be limited by these terms. These terms are only used to distinguish one element from another. For example, first ranking criteria could be termed second ranking criteria, and, similarly, second ranking criteria could be termed first ranking criteria, without departing from the scope of the present invention. First ranking criteria and second ranking criteria are both ranking criteria, but they are not the same ranking criteria.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

While the foregoing disclosure discusses illustrative aspects and/or embodiments, it should be noted that various changes and modifications could be made herein without departing from the scope of the described aspects and/or embodiments as defined by the appended claims.

1. A method, comprising:
at a computing device having one or more processors and memory for storing one or more programs to be executed by the one or more processors,
clustering users in a community to form a community user circle according to original community data of the users, attributes of the users, a bulletin board system participated by the users, or a chat group of an instant messaging application participated by the users, wherein the original community data of a user comprise information about following-up of the user on another user in the community, and an amount of topics which both the user and the another user take part in; and
creating a knowledge graph corresponding to the community user circle according to user behavior data generated by users in the community user circle.

2. The method according to claim 1, wherein the clustering users in a community to form a community user circle according to original community data of the users comprises:
calculating a closeness score of a user in the community with respect to another user in the community according to original community data of the user, wherein the closeness score of the user is used for indicating a closeness degree of the user with respect to the another user; and
clustering users according to respective closeness scores of each user with respect to other users, so as to form the community user circle.

3. The method according to claim 2, wherein the calculating a closeness score of a user in the community with respect to another user in the community according to original community data of the user comprises:
calculating a following-up score of a user with respect to another user according to the information about following-up of the user on the another user in the community;
calculating a common-hot-topic score of the user according to the amount of topics which both the user and the another user take part in; and
calculating the closeness score of the user with respect to the another user according to the following-up score and common-hot-topic score of the user with respect to the another user.

4. The method according to claim 2, wherein the clustering users according to respective closeness scores of each user with respect to other users, so as to form the community user circle comprises:
selecting a user from the community;
calculating a distance between the user and each of remaining users in the community according to the closeness score of the user with respect to the each of remaining users in the community and the closeness score of the each of remaining users in the community with respect to the user; and
determining a user whose distance from the user is less than a preset user-distance threshold, the determined user and the user forming the community user circle.

5. The method according to claim 2, wherein the clustering users according to closeness scores of each user with respect to other users, so as to form the community user circles comprises:
selecting a user in the community, other users in the community forming a first user set;
calculating respective distances of the selected user with each user of the first user set according to respective closeness scores of the selected user with respect to the each user of the first user set and respective closeness scores of the each user of the first user set with respect to the selected user;
forming the selected user and a user contained in the first user set which has a minimum distance with the selected user into a second user set, wherein users contained in the first user set but not contained in the second user set are considered as a third user set;
calculating an amount of an effective party of a user contained in the third user set with respect to the second user set;
determining an amount of a user in the third user who has a greatest amount of effective parties with respect to the second user set;
in the case that the determined amount of the user in the third user who has the greatest amount of effective parties is greater than 0, adding the user who has the greatest number of effective parties into the second user set;
calculating an amount of an effective party of a user contained in the second user set with respect to each of other users contained in the second user set;
determining a user who has a least amount of the effective party;
in the case that an amount of the user who has the least amount of the effective party is less than one half of the amount of the user who has been added in the second user set, deleting from the second user set the user who has the least amount of the effective party;
in the case that the amount of users in the second user set is equal to or great than a first threshold and less than or equal to a second threshold, forming all users contained in the second user set into the community user circle.

6. The method according to claim 1, wherein the creating a knowledge graph corresponding to the community user circle according to user behavior data generated by users in the community user circle comprises:
obtaining user behavior data generated by each user in the community user circle, user behavior data which belong to a same theme forming a text; and
mining the text to obtain a knowledge graph corresponding to the community user circle.

7. The method according to claim 6, wherein the mining the text to obtain a knowledge graph corresponding to the community user circle comprises:
performing word segmentation on data contained in the text, so as to get segmented words of the text, the segmented words of the text forming eigenvectors of the text;
clustering texts according to eigenvectors of each text, texts with a same topic forming a text clustering; and
mining texts contained in the text clustering to obtain the knowledge graph corresponding to the community user circle.

8. A system, comprising at least a processor operating in conjunction with a memory and a plurality of components, the plurality of components comprising:
a clustering module, configured to cluster users in a community to form a community user circle according to original community data of the users, attributes of the users, a bulletin board system participated by the users, or a chat group of an instant messaging application participated by the users, wherein the original community data of a user comprise information about following-up of the user on another user in the community, and an amount of topics which both the user and the another user take part in; and
a creating module, configured to create a knowledge graph corresponding to the community user circle according to user behavior data generated by users in the community user circle.

9. The system according to claim 8, wherein the clustering module comprises:
a first calculating unit, configured to calculate a closeness score of a user in the community with respect to another user in the community according to original community data of the user, wherein the closeness score of the user is used for indicating a closeness degree of the user with respect to the another user; and
a clustering unit, configured to cluster users according to respective closeness scores of each user with respect to other users, so as to form the community user circle.

10. The system according to claim 9, wherein the first calculating unit comprises:
a first calculating sub-unit, configured to calculate a following-up score of a user with respect to another user according to the information about following-up of the user on the another user in the community;
a second calculating sub-unit, configured to calculate a common-hot-topic score of the user according to the amount of topics which both the user and the another user take part in; and
a third calculating sub-unit, configured to calculate the closeness score of the user with respect to the another user according to the following-up score and common-hot-topic score of the user with respect to the another user.

11. The system according to claim 9, wherein the clustering unit comprises:
a fourth calculating sub-unit, configured to select a user from the community, and to calculate a distance of the user from each of remaining users in the community according to the closeness score of the user with respect to the each of remaining users in the community and the closeness score of the each of remaining users in the community with respect to the user; and
a clustering sub-unit, configured to determine a user whose distance from the user is less than a preset user-distance threshold, the determined user and the user forming the community user circle.

12. The system according to claim 9, wherein the clustering unit comprises:
a selecting sub-unit, configured to:
select a user in the community, wherein other users in the community form a first user set; and
calculate respective distances of the selected user with each user of the first user set according to respective closeness scores of the selected user with respect to the each user of the first user set and respective closeness scores of the each user of the first user set with respect to the selected user;
a determining sub-unit, configured to:
form the selected user and a user contained in the first user set which has a minimum distance with the selected user into a second user set, wherein users contained in the first user set but not contained in the second user set are considered as a third user set;
calculate an amount of an effective party of a user contained in the third user set with respect to the second user set; and
determine an amount of a user in the third user who has a greatest amount of effective parties with respect to the second user set;
a deleting sub-unit, configured to:
in the case that the determined amount of the user in the third user who has the greatest amount of effective parties is greater than 0, add the user who has the greatest number of effective parties into the second user set;
calculate an amount of an effective party of a user contained in the second user set with respect to each of other users contained in the second user set;
determine a user who has a least amount of the effective party; and
in the case that an amount of the user who has the least amount of the effective party is less than one half of the amount of the user who has been added in the second user set, delete from the second user set the user who has the least amount of the effective party; and
a clustering sub-unit, configured to in the case that the amount of users in the second user set is equal to or great than a first threshold and less than or equal to a second threshold, form all users contained in the second user set into the community user circle.

13. The system according to claim 8, wherein the creating module comprises:
a forming unit, configured to obtain user behavior data generated by each user in the community user circle, and to form user behavior data which belong to a same theme into a text; and
a mining unit, configured to mine the text to obtain a knowledge graph corresponding to the community user circle.

14. The system according to claim 13, wherein the mining unit comprises:
a word-segmentation sub-unit, configured to perform word segmentation on data contained in the text, so as to get segmented words of the text, the segmented words of the text forming eigenvectors of the text;
a second clustering sub-unit, configured to cluster texts according to eigenvectors of each text, texts with a same topic forming a text clustering; and
a mining sub-unit, configured to mine texts contained in the text clustering to obtain the knowledge graph corresponding to the community user circle.

15. A non-transitory computer-readable storage medium storing instructions thereon for execution by at least one processing circuit, the instructions comprising:
clustering users in a community to form a community user circle according to original community data of the users, attributes of the users, a bulletin board system participated by the users, or a chat group of an instant messaging application participated by the users, wherein the original community data of a user comprise information about following-up of the user on another user in the community, and an amount of topics which both the user and the another user take part in; and
creating a knowledge graph corresponding to the community user circle according to user behavior data generated by users in the community user circle.

16. The non-transitory computer-readable storage medium according to claim 15, wherein the clustering users in a community to form a community user circle according to original community data of the users comprises:
calculating a closeness score of a user in the community with respect to another user in the community according to original community data of the user, wherein the closeness score of the user is used for indicating a closeness degree of the user with respect to the another user; and
clustering users according to respective closeness scores of each user with respect to other users, so as to form the community user circle.

17. The non-transitory computer-readable storage medium according to claim 16, wherein the calculating a closeness score of a user in the community with respect to another user in the community according to original community data of the user comprises:
calculating a following-up score of a user with respect to another user according to the information about following-up of the user on the another user in the community;
calculating a common-hot-topic score of the user according to the amount of topics which both the user and the another user take part in; and
calculating the closeness score of the user with respect to the another user according to the following-up score and common-hot-topic score of the user with respect to the another user.

18. The non-transitory computer-readable storage medium according to claim 16, wherein the clustering users according to respective closeness scores of each user with respect to other users, so as to form the community user circle comprises:
selecting a user from the community;
calculating a distance between the user and each of remaining users in the community according to the closeness score of the user with respect to the each of remaining users in the community and the closeness score of the each of remaining users in the community with respect to the user; and
determining a user whose distance from the user is less than a preset user-distance threshold, the determined user and the user forming the community user circle.

19. The non-transitory computer-readable storage medium according to claim 16, wherein the clustering users according to closeness scores of each user with respect to other users, so as to form the community user circles comprises:
selecting a user in the community, other users in the community forming a first user set;
calculating respective distances of the selected user with each user of the first user set according to respective closeness scores of the selected user with respect to the each user of the first user set and respective closeness scores of the each user of the first user set with respect to the selected user;
forming the selected user and a user contained in the first user set which has a minimum distance with the selected user into a second user set, wherein users contained in the first user set but not contained in the second user set are considered as a third user set;
calculating an amount of an effective party of a user contained in the third user set with respect to the second user set;
determining an amount of a user in the third user who has a greatest amount of effective parties with respect to the second user set;
in the case that the determined amount of the user in the third user who has the greatest amount of effective parties is greater than 0, adding the user who has the greatest number of effective parties into the second user set;
calculating an amount of an effective party of a user contained in the second user set with respect to each of other users contained in the second user set;
determining a user who has a least amount of the effective party;
in the case that an amount of the user who has the least amount of the effective party is less than one half of the amount of the user who has been added in the second user set, deleting from the second user set the user who has the least amount of the effective party;
in the case that the amount of users in the second user set is equal to or great than a first threshold and less than or equal to a second threshold, forming all users contained in the second user set into the community user circle.

20. The non-transitory computer-readable storage medium according to claim 15, wherein the creating a knowledge graph corresponding to the community user circle according to user behavior data generated by users in the community user circle comprises:
obtaining user behavior data generated by each user in the community user circle, user behavior data which belong to a same theme forming a text; and
mining the text to obtain a knowledge graph corresponding to the community user circle.

21. (canceled)
